(19) United States
(12) Patent Application Publication
(10) Pub. No.: US 2020/0310588 A1
(43) Pub. Date: Oct. 1, 2020

(54) Electronic Device and Method of Operating an Electronic Device

(71) Applicant: Vestel Elektronik Sanayi ve Ticaret A.S., Manisa (TR)

(72) Inventor: Ahmet ÖZEL, Manisa (TR)

(21) Appl. No.: 16/759,646

(22) PCT Filed: Dec. 27, 2017
(86) PCT No.: PCT/EP2017/084659

§ 371 Date: Apr. 27, 2020

(30) Foreign Application Priority Data
Oct. 27, 2017 (EP) 17199038.5

(51) Int. Cl. G06F 3/042

(52) U.S. Cl. CPC G06F 3/0421

(57) ABSTRACT

An electronic device comprises a light source, a light sensor and a light conveyor configured to convey light from the light source to the light sensor and to allow an amount of light conveyed from the light source to the light sensor to be adjusted in response to a user input. The electronic device further comprises an input command unit configured to output an input command based on an amount of light sensed by the light sensor.

### CROSS REFERENCE TO RELATED APPLICATION

This application is a US 371 application from PCT/EP2017/084659 entitled “Electronic Device and Method of Operating an Electronic Device” filed on Dec. 27, 2017 and published as WO 2019/081050 A1 on May 2, 2019, which claims priority to EP Application 17199038.5 filed on Oct. 27, 2017. The technical disclosures of every application and publication listed in this paragraph are hereby incorporated herein by reference.

### TECHNICAL FIELD

The present disclosure relates to an electronic device and a method of operating an electronic device.

### BACKGROUND

Conventional electronic devices, such as mobile phones, handheld games consoles, etc., are equipped with user interface elements and input command units configured to output input commands in response to a user interacting with the user interface elements. The user interface elements are located on the housing of the electronic devices and typically comprise a touch screen, a press button, a slide buttons, a knob, a scroll wheel, joy stick or other.

### SUMMARY

According to a first aspect disclosed herein, there is provided an electronic device comprising:

a light source;

a light sensor;

a light conveyor configured to convey light from the light source to the light sensor and to allow the amount of light conveyed from the light source to the light sensor to be adjusted in response to a user input;

an input command unit configured to output an input command based on an amount of light sensed by the light sensor.

The user input may adjust the amount of light sensed by the light sensor by selectively adjusting an optical property of the light conveyor (e.g. a reflection coefficient). The input command may determine the amount of light sensed by the light sensor and output an input command.

The light conveyor may comprise a light guide.

The electronic device may comprise a housing with an opening to be selectively obstructed by a user. For example, the opening is located on a rear surface of the housing.

The light conveyor wherein the light conveyor may comprise a light guide, and where the electronic device may comprise a housing with an opening to be selectively obstructed by a user, wherein a non optically insulated portion (e.g. at least partially non cladded and/or non-coated) may face the opening to be selectively obstructed by a user.

The electronic device may comprise a display panel and the light source may be arranged additionally to illuminate the display panel.

For example, the light source may be a backlight or part of a backlight for the display panel.

The input command unit may be configured to output an input command when the amount of light sensed by the light sensor is above a determined threshold or a variation in the amount of light sensed by the light sensor is above a determined threshold.

The electronic device may comprise:

a control unit configured to take an action in response to receiving the output input command when a compatible application is running on the electronic device.

A compatible application is an application that accepts input command from the input command unit and that takes a determined action when the input command is received.

The electronic device may be configured such that the action depends on the compatible application that is running on the electronic device. For example, in the case that the electronic device is a handheld game console, smart phone running a computer games, game controller, etc., the action (e.g. kicking a ball) when a first compatible application is running on the electronic device (e.g. a football video game) is different from the action (e.g. punching) when a second compatible application is running on the electronic device (e.g. boxing video game).

The electronic device may a mobile device.

According to a second aspect disclosed herein, there is provided a method of operating an electronic device, the method comprising:

following a user input which causes the amount of light conveyed by a light conveyor from a light source to a light sensor to be adjusted, determining an amount of light sensed by the light sensor; and

outputting an input command based on the determined amount of light.

The method may comprise:

determining whether a compatible application is running on the electronic device and taking an action in response the output input command when a compatible application is running on the electronic device.

The action may depend on the compatible application that is running on the electronic device.

The method may comprise:

determining whether a compatible application is running on the electronic device and ignoring the output input command when no compatible application is running on the electronic device.

### BRIEF DESCRIPTION OF THE DRAWINGS

To assist understanding of the present disclosure and to show how embodiments may be put into effect, reference is made by way of example to the accompanying drawings in which:

FIG. 1 shows schematically an example of an electronic device according to an embodiment; and

FIG. 2 shows schematically an example of a method of operating the electronic device of FIG. 1 according to an embodiment.

### DETAILED DESCRIPTION

With the increase in performance of mobile phones (e.g. processing power, memory size and battery capacity) the mobile gaming sector is expanding. An issue with conventional mobile phones is that they are provided with a limited number and type of user interface elements. As a result, playing a mobile game is not always convenient and sometimes even impossible. Similar problems arise for handheld games consoles, computer games games controllers, etc. There is a need to provide mobile phones and other such electronic devices with additional user interface elements which can be easily integrated in existing mobile phones.

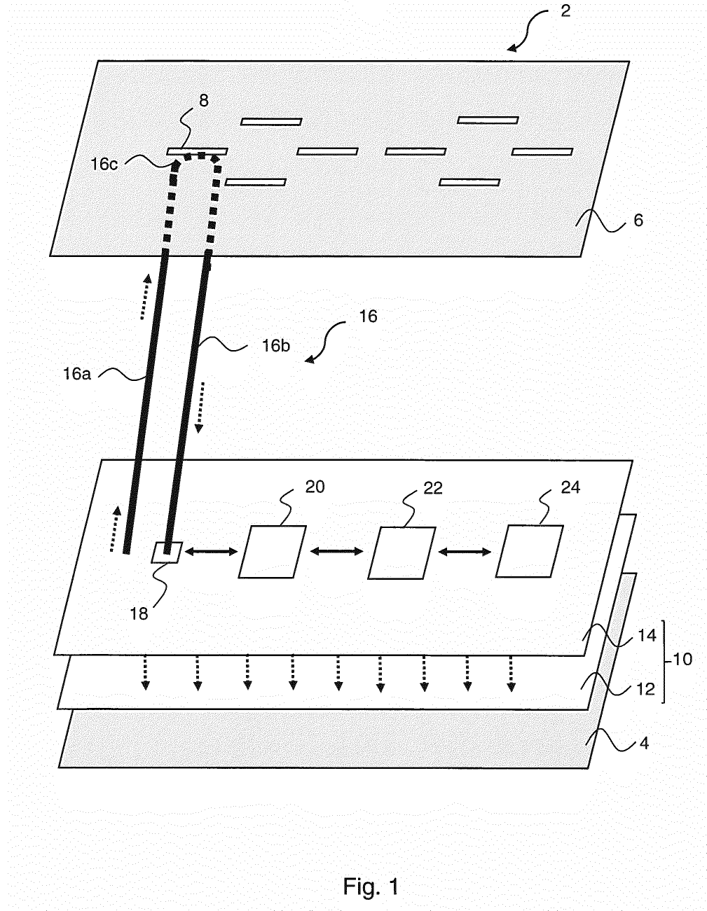

FIG. 1 shows schematically an example of a mobile phone 2 according to an embodiment. The mobile phone 2 comprises a housing including a front face 4, a rear face 6 and lateral faces (not shown). The front face 4 refers to the face intended to be directed towards a user. The front face 4 comprise a window behind which is visible a display panel. Alternatively, the front face 4 directly comprises the display panel.

The rear face 6 comprises a plurality of openings 8. Here, each opening 8 is a slit and has a rectangular shape. However, it will be understood that each opening 8 can have a different shape (e.g. square, oval, triangular or other).

The mobile phone 2 comprises a display unit 10 for displaying information for the user. The displayed unit 10 may be any type of display unit such as an LCD (liquid crystal display) display unit or an OLED (organic light emitting diode) display unit. The display unit 10 comprises a display panel 12 and a light source 14 to illuminate the display panel 12.

Here, the light source 14 is a light panel. The light source is arranged behind the screen 12 and is part of a backlight source for the display panel 12. However, it will be understood that the light source 14 is not necessarily part of a backlight source, nor necessarily illuminates the display panel.

In an implementation, the light source 14 may be part of a side light source for the display panel 12. In another implementation, the light source 14 may not be part of a light source for the display panel 12 and may instead be a separate component.

The mobile phone 2 comprises a plurality of light guides 16 (although only one light guide 16 is represented on FIG. 1 for clarity sake). Each light guide may comprise an optical fibre 16 and is configured to convey light from the light source 14 to a respective light sensor 18.

Each light guide 16 is associated with a respective opening 8. Each light guide 16 comprises an intermediate portion 16c optically connecting distal portions 16a, 16b. The distal portion 16a is also optically connected to the light source 14. The distal portion 16b is also optically connected to the light sensor 18.

Here, the intermediate portion 16c extends substantially parallel to the opening 8. The intermediate portion 16c faces this opening 8 and is preferably arranged to be flushed with the rear face 6 of the housing (i.e. the intermediate portion 16c neither protrudes from the rear face 6 nor is recessed from the rear face 6). In this way, when a user obstructs the opening 8, the user can obstruct the intermediate portion 16c as well.

The distal portions 16a, 16b may be optically insulated (e.g. cladded and coated) so that they have a higher reflection coefficient. The intermediate portion 16c may not be optically insulated (e.g. non-cladded and/or non-coated) or may be only partly optically insulated so that it has a lower reflection coefficient. For example, at least a surface of the intermediate portion 16c facing the opening 8 may not be optically insulated only partly optically insulated.

The light sensor 18 is configured to sense light from the light guide 16 and to convert this light into an electrical signal. The electrical signal is representative of an amount of light sensed by the light sensor 18. For example, at least one value (e.g. voltage, current, sweeping range, duty cycle, frequency or other) of the electrical signal is proportional to the amount of light sensed by the light sensor 18.

When a user obstructs the opening (e.g. with a finger), the user increases the reflection coefficient of the intermediate portion 16c and therefore increases the amount of light conveyed from the light source 14 to the light sensor 18. The light sensor 18 senses the light from the light guide 16 and outputs an electrical signal representative of the amount of light sensed by the light sensor 18.

The mobile phone 2 comprises an input command unit 20 electrically connected to the light sensor 18. The input command unit 20 is then configured to output an input command based on the electrical signal output by the light sensor 18.

In one implementation, the input command unit 20 is configured to determine an amount of light sensed by the light sensor 18 and to output an input command when the amount of light sensed by the light sensor is above or below a threshold.

In another implementation, the input command unit 20 is configured to determine a variation in the amount of light sensed by the light sensor 18 and to output an input command when the variation in the amount of light sensed by the light sensor is above or below a threshold.

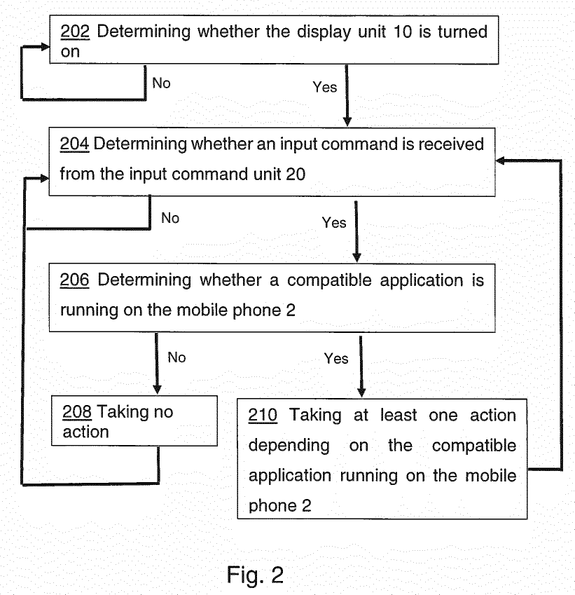

The mobile phone 2 comprises a control unit 22 (or processor) and a memory 24. The memory 24 comprises a computer program which when executed by the control unit 22 allow the control unit to perform the method of FIG. 2.

The control unit 22 is configured to receive an input command from the input command unit 20 and to take an action when a compatible application is running. A compatible application is an application that accepts input command from the input command unit 20 and that takes a determined action when the input command is received. It will be understood that an application may be any piece of software program that can be run by the mobile phone 2. The application as used herein may for example include the operating system of the mobile phone 2.

The action taken by the control unit may be specific to the application running on the mobile phone 2. That is, the action (e.g. kicking a ball) taken upon reception of an input command originating from a light guide 16 when a first compatible application (e.g. a football video game) is running on the mobile phone 2 is different from the action (e.g. punching) taken upon reception of an input command originating from the same light guide 16 when a second compatible application (e.g. a boxing video game) is running on the mobile phone 2.

FIG. 2 shows schematically an example of a method of operating the mobile phone 2 of FIG. 1 in an embodiment.

In step 202, the control unit 22 determines whether the display unit 10 is turned on and therefore whether the light source 14 is illuminating the display panel 12. If the display unit 10 is turned off the method loops back to step 202. If the display unit 10 is turned on the method goes to step 204.

In step 204, the control unit 22 determines whether an input command is received from the input command unit 20. If the control unit 22 does not receive an input command from the input command unit 20, the method loops back to step 204. Alternatively, the method may loop back to step 202.

In step 206, the control unit 22 determines whether a compatible application is running on the electronic device 2. If no compatible application is running on the electronic device 2, the method goes to step 208. If a compatible application is running on the electronic device 2, the method goes to step 210.

In step 208, the control unit 22 takes no action and the method loops back to step 204. Alternatively, the method may loop back to step 202.

In step 210, the control unit 22 takes an action depending on the compatible application and the method loops back to step 204. Alternatively, the method may loop back to step 202. For example, the action (e.g. kicking a ball) when a first compatible application is running on the electronic device (e.g. a football video game) is different from the action (e.g. punching) when a second compatible application is running on the electronic device (e.g. a boxing video game).

It will be understood that although the mobile phone 2 has been described above, the teachings of this disclosure are applicable to any electronic device. For example, there are applicable to a tablet computer, laptop computer, game console (including in particular handheld games consoles), computer mouse, camera, desktop computer or other.

It will also be understood that although the compatible application described above are mobile games, any application may be compatible. For example, a text editing application, a drawing applications, a diary application, a dating application, a social media application or other can be compatible. The actions taken when an input command is received can comprise add space, delete character, copy string character or other to allow a user to type faster.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), graphics processing units (GPUs), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

Reference is made herein to memory for storing data. This may be provided by a single device or by plural devices. Suitable devices include for example a hard disk and non-volatile semiconductor memory.

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. An electronic device comprising:
a light source;
a light sensor;
a light conveyor configured to convey light from the light source to the light sensor and to allow the amount of light conveyed from the light source to the light sensor to be adjusted in response to a user input;
an input command unit configured to output an input command based on an amount of light sensed by the light sensor.

2. An electronic device according to claim 1, wherein the light conveyor comprises a light guide.

3. An electronic device according to claim 1, comprising a housing with an opening to be selectively obstructed by a user.

4. An electronic device according to claim 1, wherein the light conveyor comprises a light guide, and comprising a housing with an opening to be selectively obstructed by a user, wherein the light guide comprises a portion facing the opening to be selectively obstructed by a user.

5. An electronic device according to claim 1, comprising a display panel, wherein the light source is arranged additionally to illuminate the display panel.

6. An electronic device according to claim 1, wherein the input command unit is configured to output an input command when the amount of light sensed by the light sensor is above a determined threshold or a variation in the amount of light sensed by the light sensor is above a determined threshold.

7. An electronic device according to claim 1, comprising:
a control unit configured to take an action in response to receiving the output input command when a compatible application is running on the electronic device.

8. An electronic device according to claim 7, configured such that the action depends on the compatible application that is running on the electronic device.

9. An electronic device according to claim 1, wherein the electronic device is a mobile device.

10. A method of operating an electronic device, the method comprising:
following a user input which causes the amount of light conveyed by a light conveyor from a light source to a light sensor to be adjusted, determining an amount of light sensed by the light sensor; and
outputting an input command based on the determined amount of light.

11. A method according to claim 10, comprising:
determining whether a compatible application is running on the electronic device and taking an action in response to the output input command when a compatible application is running on the electronic device.

12. A method according to claim 11, wherein the action depends on the compatible application that is running on the electronic device.

13. A method according to claim 10, comprising:
determining whether a compatible application is running on the electronic device and ignoring the output input command when no compatible application is running on the electronic device.
